(19) United States
(12) Patent Application Publication
(10) Pub. No.: US 2022/0379790 A1
(43) Pub. Date: Dec. 1, 2022

(54) VEHICLE HAVING A SEATING ASSEMBLY AND TRAY TABLE

(71) Applicant: Ford Global Technologies, LLC, Dearborn, MI (US)

(72) Inventors: Johnathan Andrew Line, Northville, MI (US); Jimmy Moua, Canton, MI (US); Kevin Wayne Preuss, Berkley, MI (US); Sean Bayle West, Monroe, MI (US); Nicholas Alphonse Billardello, Macomb, MI (US)

(73) Assignee: Ford Global Technologies, LLC, Dearborn, MI (US)

(21) Appl. No.: 17/331,026

(22) Filed: May 26, 2021

(51) Int. Cl. B60N 3/00; B60N 2/01; B60N 2/04

(52) U.S. Cl. CPC B60N 3/004; B60N 2/01; B60N 2/04

(57) ABSTRACT

A vehicle includes a floor. An anchoring feature is coupled to the floor and includes a guide rail. A seating assembly is coupled to the guide rail and is operable to pitch vehicle-forward from a first position to a second position. A tray table assembly is coupled to the anchoring feature and is operable to remain generally stationary relative to the anchoring feature as the seating assembly moves between the first and second positions.

### FIELD OF THE DISCLOSURE

The present disclosure generally relates to a system for a vehicle interior and, more particularly, to a tray table assembly and a seating assembly positioned within a vehicle interior.

### BACKGROUND OF THE DISCLOSURE

Vehicles include seating assemblies.

### SUMMARY OF THE DISCLOSURE

According to a first aspect of the present disclosure, the vehicle includes a floor. An anchoring feature is coupled to the floor. A seating assembly is coupled to the anchoring feature. The seating assembly includes a seat that extends from a proximal end to a distal end that is seating assembly-forward of the proximal end, and a seatback that is coupled to the seat. The seatback includes a first end that is proximate to the proximal end of the seat and a second end that is further than the first end from the proximal end. The seating assembly is operable to pivot between a first position, wherein the proximal end of the seat is a first distance from a portion of the anchoring feature and the first end of the seatback is a second distance from the portion of the anchoring feature, and a second position, wherein the proximal end of the seat is a third distance from the portion of the anchoring feature and the first end of the seatback is a fourth distance from the portion of the anchoring feature. The third distance is greater than the first distance and the fourth distance is greater than the second distance. A tray table assembly is coupled to the anchoring feature and is operable to remain generally stationary relative to the anchoring feature as the seating assembly pivots between the first and second positions.

Embodiments of the first aspect of the present disclosure may include any one or a combination of the following features:
the tray table assembly includes a support portion coupled to the anchoring feature and a table pivotably coupled to the support portion, wherein the table is operable to pivot relative to the support portion between the use position and a stowed position;
the support portion includes a bracket coupled to the anchoring feature and having a receiving feature, and a post matingly engaged with the receiving feature of the bracket, wherein the table is operable to pivot relative to the post between the use and stowed positions;
the seatback is pivotably coupled to the seat and operable to pivot relative to the seat about a pivot axis, wherein the pivot axis is further from the portion of the anchoring feature in the second position of the seating assembly than in the first position of the seating assembly;
the anchoring feature includes a guide rail, wherein the seating assembly is operable to move along the guide rail;
the tray table assembly is mounted to a portion of the anchoring feature that is vehicle-downward of the guide rail; and
the seating assembly includes a base portion coupled to the anchoring feature, wherein the seat is configured to pivot relative to the base portion as the seating assembly moves between the first and second positions.

According to a second aspect of the present disclosure, the vehicle includes a floor and an anchoring feature coupled to the floor. A first seating assembly is coupled to the anchoring feature. A second seating assembly includes an armrest and is in a spaced relationship with the first seating assembly, such that a gap is defined between the first and second seating assemblies. The first and second seating assemblies form a row of seating of the vehicle. A tray table assembly is mounted to the anchoring feature. The tray table assembly includes a table that is operable to pivot into the gap between the first and second seating assemblies toward the second seating assembly from a stowed position to a use position. A side tray is pivotably coupled to the armrest of the second seating assembly and is operable to pivot into the gap between the first and second seating assemblies toward the first seating assembly from a retracted position to a deployed position.

Embodiments of the second aspect of the present disclosure may include any one or a combination of the following features:
in the deployed position of the side tray and the use position of the table, the side tray is directly vehicle-upward of the table;
the table pivots a first direction from the stowed position to the use position, and the side tray pivots a second direction from the retracted position to the deployed position, wherein the second direction is opposite the first direction;
the first seating assembly includes a seat that extends from a proximal end to a distal end seating assembly-forward of the proximal end, and a seatback coupled to the seat and having a first end that is proximate to the proximal end of the seat and a second end that is further than the first end from the proximal end, wherein the first seating assembly is operable to pivot between a first position, wherein the proximal end of the seat is a first distance from a portion of the anchoring feature and the first end of the seatback is a second distance from the portion of the anchoring feature, and a second position, wherein the proximal end of the seat is a third distance from the portion of the anchoring feature and the first end of the seatback is a fourth distance from the portion of the anchoring feature, wherein the third distance is greater than the first distance and the fourth distance is greater than the second distance, and wherein the tray table assembly is operable to remain generally stationary relative to the anchoring feature as the first seating assembly pivots between the first and second positions;
the tray table assembly includes a support portion coupled to the anchoring feature, and the table pivotably coupled to the support portion, wherein the table is operable to pivot relative to the support portion between the use position and the stowed position;
the support portion includes a bracket coupled to the anchoring feature and having a receiving feature, and a post matingly engaged with the receiving feature of the bracket, wherein the table is operable to pivot relative to the post between the use and stowed positions;
the seatback is pivotably coupled to the seat and operable to pivot relative to the seat about a pivot axis, wherein the pivot axis is further from the portion of the anchoring feature in the second position of the first seating assembly than in the first position of the first seating assembly;
the anchoring feature includes a guide rail, wherein the first seating assembly is operable to move along the guide rail;
the tray table assembly is mounted to a portion of the anchoring feature that is vehicle-downward of the guide rail;
the first seating assembly includes a base portion coupled to the anchoring feature, wherein the seat is configured to pivot relative to the base portion as the first seating assembly moves between the first and second position;
the base portion is operable to move along the guide rail; and
the table is positioned directly vehicle-downward of the armrest of the second seating assembly in the use position.

According to third aspect of the present disclosure, a vehicle includes a floor. An anchoring feature is coupled to the floor and includes a guide rail. A seating assembly is coupled to the guide rail and is operable to pitch vehicle-forward from a first position to a second position. A tray table assembly is coupled to the anchoring feature and is operable to remain generally stationary relative to the anchoring feature as the seating assembly moves between the first and second positions.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a vehicle, according to one embodiment;

FIG. 2 is a perspective view of a vehicle interior of the vehicle, illustrating first and second seating assemblies in a row of seating, a tray table assembly, and a side tray coupled to an armrest of the second seating assembly, according to one embodiment;

FIG. 3 is a perspective view of the first and second seating assemblies, illustrating the side tray in a retracted position and the tray table assembly in a stowed position, according to one embodiment;

FIG. 4 is a perspective view of the first and second seating assemblies, illustrating the side tray in a deployed position and a table of the tray table assembly in a use position, according to one embodiment;

FIG. 5 is a perspective view of the tray table assembly and an anchoring feature, illustrating a bracket of the tray table assembly coupled to the anchoring feature and first and second posts of the tray table assembly aligned with receiving features of the bracket that are configured to receive the first and second posts of the tray table assembly therein in an assembled condition, according to one embodiment;

FIG. 6A is a side elevational view of the seating assembly and the tray table assembly coupled to the anchoring feature, illustrating the seating assembly in a first position, according to one embodiment; and

FIG. 6B is a side elevational view of the seating assembly and the tray table assembly coupled to the anchoring feature, illustrating the seating assembly in a second position, according to one embodiment.

### DETAILED DESCRIPTION OF THE PREFERRED EMBODIMENTS

Additional features and advantages of the present disclosure will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

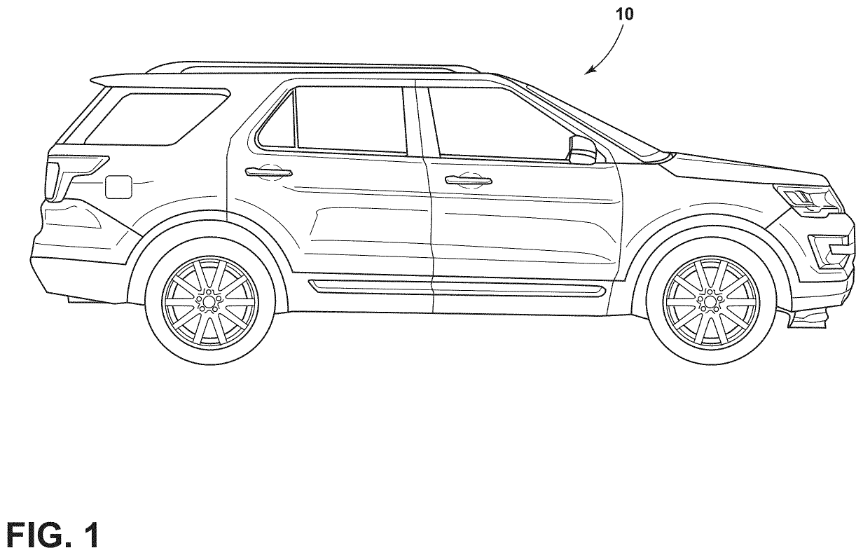

Referring now to FIGS. 1-6B, a vehicle 10 includes a floor 42. An anchoring feature 38 is coupled to the floor 42. A seating assembly 14 is coupled to the anchoring feature 38. The seating assembly 14 includes a seat 20 that extends from a proximal end 22 to a distal end 24 that is seating assembly-forward of the proximal end 22. The seating assembly 14 further includes a seatback 26 that is coupled to the seat 20. The seatback 26 includes a first end 28 that is proximate to the proximal end 22 of the seat 20 and a second end 30 that is further than the first end 28 from the proximal end 22. The seating assembly 14 is operable to pivot between a first position and a second position. In the first position, the proximal end 22 of the seat 20 is a first distance from a portion of the anchoring feature 38 and the first end 28 of the seatback 26 is a second distance from the portion of the anchoring feature 38. In the second position, the proximal end 22 of the seat 20 is a third distance from the portion of the anchoring feature 38 and the first end 28 of the seatback 26 is a fourth distance from the portion of the anchoring feature 38. The third distance is greater than the first distance, and the fourth distance is greater than the second distance. A tray table assembly 54 is coupled to the anchoring feature 38 and is operable to remain generally stationary relative to the anchoring feature 38 as the seating assembly 14 pivots between the first and second positions.

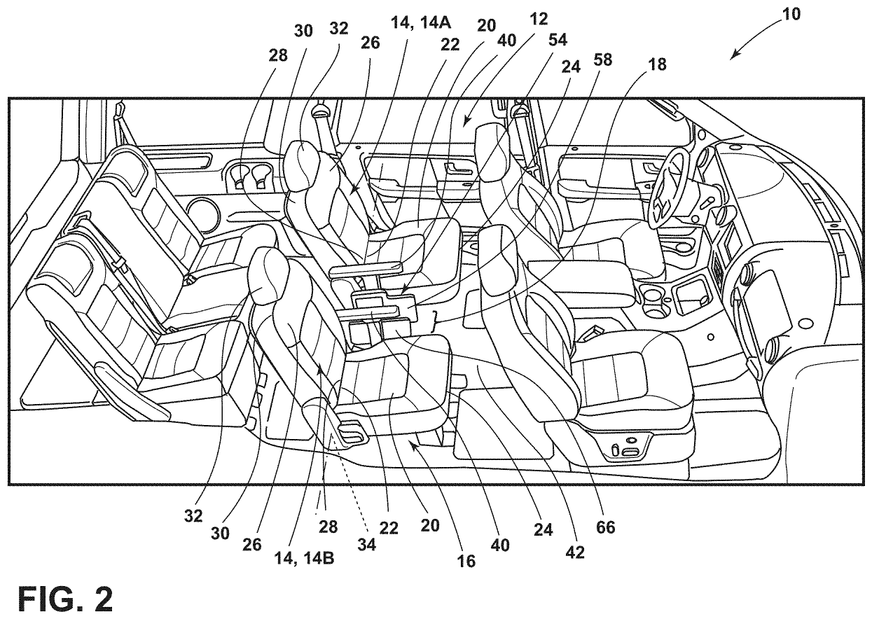

Referring now to FIGS. 1 and 2, the vehicle 10 includes a vehicle interior 12. The seating assembly 14 is disposed within the vehicle interior 12. In various embodiments, a plurality of seating assemblies 14 may be positioned within the vehicle interior 12. The seating assemblies 14 may form rows 16 of seating within the vehicle interior 12. In the embodiment illustrated in FIG. 2, the vehicle 10 includes a first seating assembly 14A and a second seating assembly 14B that are arranged in a row 16 of seating. As illustrated in FIG. 2, the first and second seating assemblies 14A, 14B are in a spaced relationship with each other, such that a gap 18 is defined between the first and second seating assemblies 14A, 14B. Various numbers and configurations of seating assemblies 14 within the vehicle interior 12 are contemplated.

Referring now to FIG. 2, the seating assembly 14 may include the seat 20. The seat 20 may extend from the proximal end 22 to the distal end 24. The distal end 24 of the seat 20 may be seating assembly-forward of the proximal end 22, as illustrated in FIG. 2. In some embodiments, the distal end 24 of the seat 20 may be vehicle-forward of the proximal end 22 of the seat 20, as further illustrated in FIG. 2. The seatback 26 may be coupled to the seat 20. The seatback 26 may include a first end 28 and a second end 30. As illustrated in FIG. 2, the first end 28 is proximate to the proximal end 22 of the seat 20 and the second end 30 is further than the first end 28 of the seatback 26 from the proximal end 22 of the seat 20. In various embodiments, a headrest 32 may be coupled to the seatback 26 of the seating assembly 14 at the second end 30 of the seatback 26.

In some implementations, the seatback 26 may be pivotably coupled to the seat 20, such that the seatback 26 is operable to pivot relative to the seat 20 about a pivot axis 34, as illustrated in FIG. 2. The first end 28 of the seatback 26 may be nearer than the second end 30 of the seatback 26 to the pivot axis 34. The proximal end 22 of the seat 20 may be nearer than the distal end 24 of the seat 20 to the pivot axis 34 about which the seatback 26 is configured to pivot relative to the seat 20.

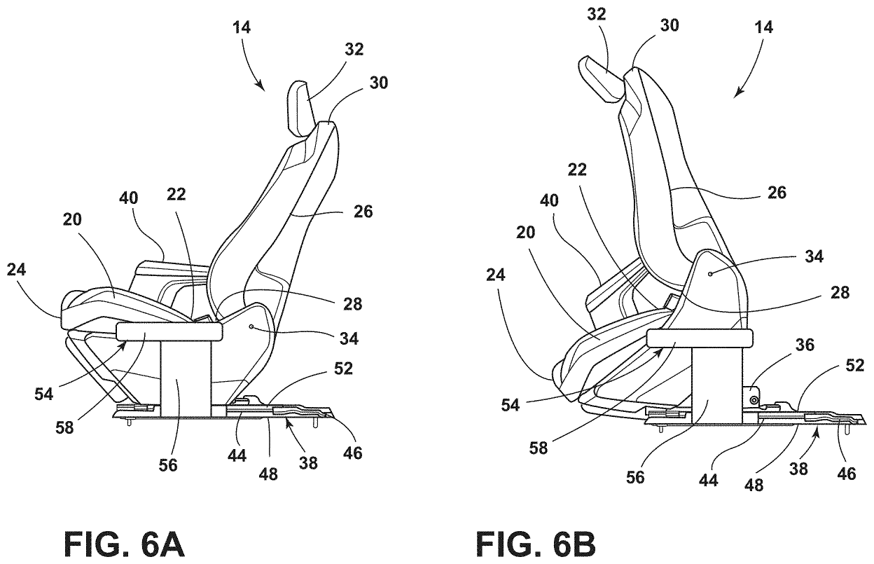

Referring now to FIGS. 2-4, 6A, and 6B, in some embodiments, the seating assembly 14 may include a base portion 36. As described further herein, the base portion 36 may be coupled to the anchoring feature 38. In some embodiments, the seat 20 may be configured to pivot relative to the base portion 36 of the seating assembly 14. As illustrated in FIGS. 6A and 6B, the seat 20 and seatback 26 may be operable to pivot in unison relative to the base portion 36 of the seating assembly 14, in some implementations. In various embodiments, the seating assembly 14 may include an armrest 40. The armrest 40 may be coupled to at least one of a variety of components of the seating assembly 14 (e.g., seat 20, seatback 26, etc.). It is contemplated that the seating assembly 14 may include first and second armrests 40, in some embodiments.

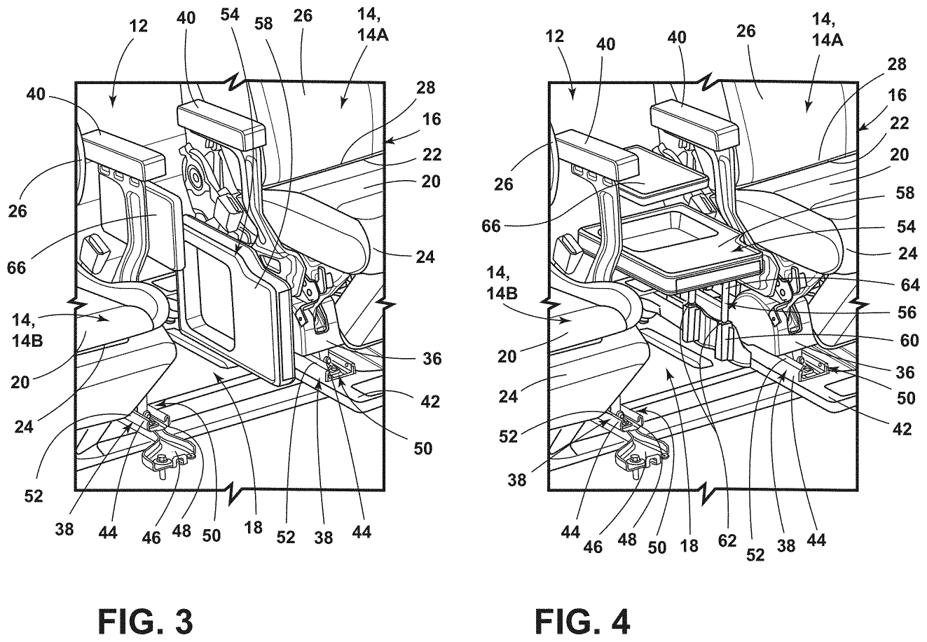

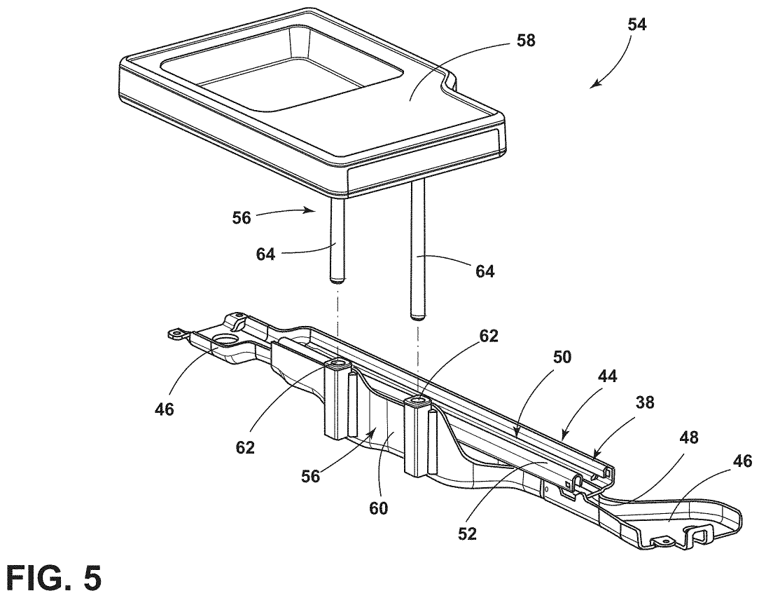

Referring now to FIGS. 3-6B, the seating assembly 14 may be coupled to the anchoring feature 38 that is coupled to the floor 42 of the vehicle 10. In some embodiments, the seating assembly 14 may be coupled to multiple anchoring features 38 that are coupled to the floor 42 of the vehicle 10. In some embodiments, the anchoring feature 38 may include a guide rail 44. For example, in the embodiment illustrated in FIG. 5, the anchoring feature 38 includes the guide rail 44 and an attachment portion 46 that extends outward from a bottom side 48 of the guide rail 44 and that is generally vehicle-downward of the guide rail 44. In the illustrated embodiment, the attachment portion 46 anchors the anchoring feature 38 to the vehicle 10. As illustrated in FIG. 5, the guide rail 44 of the anchoring feature 38 may include a channel 50 on a vehicle-upward side 52 of the guide rail 44. The channel 50 may be configured to receive a portion of the seating assembly 14 therein to couple the seating assembly 14 to the anchoring feature 38.

In various embodiments, the seating assembly 14 may be movably coupled to the anchoring feature 38. For example, the seating assembly 14 may move along the guide rail 44. In an exemplary embodiment, the portion of the seating assembly 14 that is within the channel 50 defined by the guide rail 44 may slide within the channel 50 to move the seating assembly 14 along the guide rail 44. In some embodiments, the base portion 36 of the seating assembly 14 may be coupled to the anchoring feature 38 and/or configured to move along the guide rail 44 of the anchoring feature 38.

Referring now to FIGS. 6A and 6B, the seating assembly 14 may be operable between first and second positions. In various embodiments, the seating assembly 14 may be operable to pivot between the first and second positions. As illustrated in FIGS. 6A and 6B, the seating assembly 14 may pitch vehicle-forward from the first position to the second position. In some embodiments, the seating assembly 14 may pivot relative to the anchoring feature 38 between the first and second positions. In some embodiments, wherein the seat 20 is pivotably coupled to the base portion 36 of the seating assembly 14, the seating assembly 14 may pivot between the first and second positions via pivotal movement of the seat 20 relative to the base portion 36. In the embodiment illustrated in FIGS. 6A and 6B, the seat 20 and seatback 26 coupled to the seat 20 pivot relative to the base portion 36 to pitch the seating assembly 14 vehicle-forward from the first position, as illustrated in FIG. 6A, to the second position, as illustrated in FIG. 6B.

Referring still to FIGS. 6A and 6B, in the first position of the seating assembly 14, the proximal end 22 of the seat 20 may be a first distance from a portion of the anchoring feature 38 and the first end 28 of the seatback 26 may be a second distance from the portion of the anchoring feature 38. In the second position of the seating assembly 14, the proximal end 22 of the seat 20 may be a third distance from the portion of the anchoring feature 38 and the first end 28 of the seatback 26 may be a fourth distance from the portion of the anchoring feature 38. The third distance may be greater than the first distance, and the fourth distance may be greater than the second distance. In some embodiments, wherein the seatback 26 is pivotably coupled to the seat 20 and operable to pivot relative to the seat 20 about the pivot axis 34 and the seating assembly 14 is operable between the first and second positions, the pivot axis 34 about which the seatback 26 pivots relative to the seat 20 may be further from a portion of the anchoring feature 38 in the second position of the seating assembly 14 than in the first position of the seating assembly 14.

Referring now to FIGS. 2-6B, the vehicle 10 includes the tray table assembly 54. The tray table assembly 54 may be coupled to the anchoring feature 38 of the vehicle 10. In some embodiments, the tray table assembly 54 may be mounted to a portion of the anchoring feature 38 that is vehicle-downward of the guide rail 44. For example, the tray table assembly 54 may be coupled to the attachment portion 46 of the anchoring feature 38, in some embodiments. The tray table assembly 54 may include a support portion 56 and a table 58. The support portion 56 may be coupled to the anchoring feature 38 of the vehicle 10. In an exemplary embodiment, the support portion 56 may include a bracket 60 that is coupled to the anchoring feature 38 and that includes a receiving feature 62, and a post 64 that is matingly engaged with the receiving feature 62 of the bracket 60. In the embodiment illustrated in FIG. 5, the support portion 56 includes the bracket 60, which is coupled to the guide rail 44 and the attachment portion 46 of the anchoring feature 38, and first and second posts 64 that are configured to matingly engage first and second receiving features 62 of the bracket 60.

The table 58 of the tray table assembly 54 may be coupled to the support portion 56. In various embodiments, the table 58 may be pivotably coupled to the support portion 56 and operable to pivot relative to the support portion 56 between a use position, as illustrated in FIG. 4, and a stowed position, as illustrated in FIG. 3. In some embodiments, the table 58 may be operable to pivot relative to the post 64 of the support portion 56 of the tray table assembly 54 between the use and stowed positions. It is contemplated that the table 58 of the tray table assembly 54 may include one or more fixed or deployable cup holder assemblies and/or storage receptacles, in various embodiments.

Referring now to FIGS. 6A and 6B, in various embodiments, the tray table assembly 54 coupled to the anchoring feature 38 may be operable to remain generally stationary relative to the anchoring feature 38 as the seating assembly 14 pivots between the first and second positions. In other words, the tray table assembly 54 may not move with the seating assembly 14 as the seating assembly 14 pivots between the first and second positions, as illustrated in FIGS. 6A and 6B.

Referring now to FIGS. 2-4, the vehicle 10 may include a side tray 66. The side tray 66 may be coupled to the seating assembly 14. In some embodiments, the side tray 66 may be coupled to the armrest 40 of the seating assembly 14. In the embodiment illustrated in FIGS. 3 and 4, the side tray 66 is pivotably coupled to the armrest 40 of the seating assembly 14 and is operable to pivot relative to the armrest 40 between a retracted position, as illustrated in FIG. 3, and a deployed position, as illustrated in FIG. 4.

Referring still to FIGS. 2-4, the first and second seating assemblies 14A, 14B are in a spaced relationship, such that the gap 18 is defined between the first and second seating assemblies 14A, 14B. As illustrated in FIGS. 3 and 4, the tray table assembly 54 is mounted to the anchoring feature 38 to which the first seating assembly 14A is coupled. The side tray 66 is pivotably coupled to the armrest 40 of the second seating assembly 14B. The table 58 of the tray table assembly 54 is operable to pivot into the gap 18 between the first and second seating assemblies 14A, 14B toward the second seating assembly 14B from the stowed position, as illustrated in FIG. 3, to the use position, as illustrated in FIG. 4. Further, the side tray 66 is operable to pivot relative to the armrest 40 of the second seating assembly 14B into the gap 18 toward the first seating assembly 14A from the retracted position, as illustrated in FIG. 3, to the deployed position, as illustrated in FIG. 4.

In various embodiments, the table 58 may pivot a first direction from the stowed position to the use position, and the side tray 66 may pivot a second direction from the retracted position to the deployed position, wherein the second direction is opposite the first direction. In some embodiments, the side tray 66 is positioned directly vehicle-upward of the table 58 of the tray table assembly 54 in the deployed position of the side tray 66 and the use position of the table 58. As illustrated in FIG. 4, in some embodiments, the table 58 of the tray table assembly 54 mounted to the anchoring feature 38 to which the first seating assembly 14A within the row 16 of seating is coupled may be positioned directly vehicle-downward of the armrest 40 of the second seating assembly 14B to which the side tray 66 is coupled while the table 58 is in the use position.

The vehicle 10 of the present disclosure may provide a variety of advantages. The table 58 of the tray table assembly 54 may provide a surface for placing items while in the use position, and may not inhibit movement of occupants of the vehicle 10 through the gap 18 between the first and second seating assemblies 14A, 14B of the vehicle 10 while in the stowed position. Second, the side tray 66 may provide a surface to place items upon while in the deployed position, and may not inhibit movement of occupants of the vehicle 10 through the gap 18 between the first and second seating assemblies 14A, 14B while in the retracted position. Third, the tray table assembly 54 being mounted to the anchoring feature 38 to which the seating assembly 14 is coupled, such that the tray table assembly 54 remains generally stationary relative to the anchoring feature 38 as the seating assembly 14 pitches vehicle-forward from the first position to the second position, may allow items (e.g., beverage container) to remain on the table 58 of the tray table assembly 54 without toppling over as the seating assembly 14 moves from the first position to the second position. Fourth, the seating assembly 14 pitching vehicle-forward from the first position to the second position may allow for convenient ingress and egress of passengers of rows 16 of seating vehicle-rearward of the seating assembly 14.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle, comprising:
a floor;
an anchoring feature coupled to the floor;
a seating assembly coupled to the anchoring feature and comprising:
a seat that extends from a proximal end to a distal end seating assembly-forward of the proximal end; and
a seatback coupled to the seat and having a first end that is proximate to the proximal end of the seat and a second end that is further than the first end from the proximal end, wherein the seating assembly is operable to pivot between a first position, wherein the proximal end of the seat is a first distance from a portion of the anchoring feature and the first end of the seatback is a second distance from the portion of the anchoring feature, and a second position, wherein the proximal end of the seat is a third distance from the portion of the anchoring feature and the first end of the seatback is a fourth distance from the portion of the anchoring feature, wherein the third distance is greater than the first distance and the fourth distance is greater than the second distance; and
a tray table assembly coupled to the anchoring feature and operable to remain generally stationary relative to the anchoring feature as the seating assembly pivots between the first and second positions.

2. The vehicle of claim 1, wherein the tray table assembly comprises:
a support portion coupled to the anchoring feature; and
a table pivotably coupled to the support portion, wherein the table is operable to pivot relative to the support portion between a use position and a stowed position.

3. The vehicle of claim 2, wherein the support portion comprises:
a bracket coupled to the anchoring feature and having a receiving feature; and
a post matingly engaged with the receiving feature of the bracket, wherein the table is operable to pivot relative to the post between the use and stowed positions.

4. The vehicle of claim 1, wherein the seatback is pivotably coupled to the seat and operable to pivot relative to the seat about a pivot axis, wherein the pivot axis is further from the portion of the anchoring feature in the second position of the seating assembly than in the first position of the seating assembly.

5. The vehicle of claim 1, wherein the anchoring feature comprises:
a guide rail, wherein the seating assembly is operable to move along the guide rail.

6. The vehicle of claim 5, wherein the tray table assembly is mounted to a portion of the anchoring feature that is vehicle-downward of the guide rail.

7. The vehicle of claim 1, wherein the seating assembly comprises:
a base portion coupled to the anchoring feature, wherein the seat is configured to pivot relative to the base portion as the seating assembly moves between the first and second positions.

8. A vehicle, comprising:
a floor;
an anchoring feature coupled to the floor;
a first seating assembly coupled to the anchoring feature;
a second seating assembly having an armrest and being in a spaced relationship with the first seating assembly, such that a gap is defined between the first and second seating assemblies, wherein the first and second seating assemblies form a row of seating of the vehicle;
a tray table assembly mounted to the anchoring feature and having a table operable to pivot into the gap between the first and second seating assemblies toward the second seating assembly from a stowed position to a use position; and
a side tray pivotably coupled to the armrest of the second seating assembly and operable to pivot into the gap between the first and second seating assemblies toward the first seating assembly from a retracted position to a deployed position.

9. The vehicle of claim 8, wherein, in the deployed position of the side tray and the use position of the table, the side tray is directly vehicle-upward of the table.

10. The vehicle of claim 8, wherein the table pivots a first direction from the stowed position to the use position, and the side tray pivots a second direction from the retracted position to the deployed position, wherein the second direction is opposite the first direction.

11. The vehicle of claim 8, wherein the first seating assembly comprises:
a seat that extends from a proximal end to a distal end seating assembly-forward of the proximal end; and
a seatback coupled to the seat and having a first end that is proximate to the proximal end of the seat and a second end that is further than the first end from the proximal end, wherein the first seating assembly is operable to pivot between a first position, wherein the proximal end of the seat is a first distance from a portion of the anchoring feature and the first end of the seatback is a second distance from the portion of the anchoring feature, and a second position, wherein the proximal end of the seat is a third distance from the portion of the anchoring feature and the first end of the seatback is a fourth distance from the portion of the anchoring feature, wherein the third distance is greater than the first distance and the fourth distance is greater than the second distance, and wherein the tray table assembly is operable to remain generally stationary relative to the anchoring feature as the first seating assembly pivots between the first and second positions.

12. The vehicle of claim 11, wherein the tray table assembly comprises:
a support portion coupled to the anchoring feature; and
the table pivotably coupled to the support portion, wherein the table is operable to pivot relative to the support portion between the use position and the stowed position.

13. The vehicle of claim 12, wherein the support portion comprises:
a bracket coupled to the anchoring feature and having a receiving feature; and
a post matingly engaged with the receiving feature of the bracket, wherein the table is operable to pivot relative to the post between the use and stowed positions.

14. The vehicle of claim 11, wherein the seatback is pivotably coupled to the seat and operable to pivot relative to the seat about a pivot axis, wherein the pivot axis is further from the portion of the anchoring feature in the second position of the first seating assembly than in the first position of the first seating assembly.

15. The vehicle of claim 11, wherein the anchoring feature comprises:
a guide rail, wherein the first seating assembly is operable to move along the guide rail.

16. The vehicle of claim 15, wherein the tray table assembly is mounted to a portion of the anchoring feature that is vehicle-downward of the guide rail.

17. The vehicle of claim 16, wherein the first seating assembly further comprises:
a base portion coupled to the anchoring feature, wherein the seat is configured to pivot relative to the base portion as the first seating assembly moves between the first and second positions.

18. The vehicle of claim 17, wherein the base portion is operable to move along the guide rail.

19. The vehicle of claim 8, wherein the table is positioned directly vehicle-downward of the armrest of the second seating assembly in the use position.

20. A vehicle, comprising:
a floor;
an anchoring feature coupled to the floor and having a guide rail;
a seating assembly coupled to the guide rail and operable to pitch vehicle-forward from a first position to a second position; and
a tray table assembly coupled to the anchoring feature and operable to remain generally stationary relative to the anchoring feature as the seating assembly moves between the first and second positions.
